(19) United States
(12) Patent Application Publication
(10) Pub. No.: US 2026/0139167 A1
(43) Pub. Date: May 21, 2026

(54) Aqueous Adhesive Composition For Textile Printing

(71) Applicant: SEIKO EPSON CORPORATION, Tokyo (JP)

(72) Inventors: Nikako TSUKIJI, Matsumoto (JP); Soichi YAMAZAKI, Shiojiri (JP); Harunobu KOMATSU, Matsumoto (JP); Koichi TERAO, Suwa (JP)

(21) Appl. No.: 19/392,408

(22) Filed: Nov. 18, 2025

(30) Foreign Application Priority Data
Nov. 19, 2024 (JP) 2024-201250

(51) Int. Cl. C09J 133/06

(52) U.S. Cl. CPC C09J 133/066; C09J 133/064

(57) ABSTRACT

An aqueous adhesive composition for textile printing according to the present disclosure contains a (meth)acrylic resin having a glass transition temperature of −30° C. or more and −5° C. or less, an anionic surfactant containing an ammonium salt, and a nonionic surfactant having a cloud point of 100° C. or more. An amount of the nonionic surfactant is preferably 0.3 parts by mass or more and 10.0 parts by mass or less based on 100 parts by mass of the (meth)acrylic resin. The anionic surfactant preferably contains an ammonium alkyl sulfate. The ammonium alkyl sulfate preferably has 12 or more carbon atoms in a molecule thereof.

The present application is based on, and claims priority from JP Application Serial Number 2024-201250, filed Nov. 19, 2024, the disclosure of which is hereby incorporated by reference herein in its entirety.

### BACKGROUND

### 1. Technical Field

The present disclosure relates to an aqueous adhesive composition for textile printing.

### 2. Related Art

In a textile printing method including applying an ink composition to a fabric as a recording medium to perform dying, an adhesive layer is formed on a surface of a transport belt that comes in contact with the fabric transported by the transport belt. This enables the fabric to be adhered and held on the transport belt, and thus the fabric can be stably transported.

To form such an adhesive layer, a liquid temporary fixing agent containing an adhesive is used. Since the adhesive layer is required to have moderate tack that allows the fabric fixed to the transport belt to be suitably attached to and detached from the transport belt and is also required to have water resistance and mechanical strength enough to withstand water washing, a temporary fixing agent in which a hydrophobic resin is dissolved in an organic solvent has been used.

The use of the temporary fixing agent containing an organic solvent imposes many restrictions on the surrounding environment, such as the necessity of sufficient ventilation, because the organic solvent volatilizes, for example, when applied to the transport belt. In view of this, there is a demand for an aqueous temporary fixing agent from which an organic solvent does not volatilize. Such an aqueous temporary fixing agent is proposed in JP-A-59-53790.

However, there has been a problem that an adhesive layer formed of the above-described temporary fixing agent has low durability and cannot withstand water washing.

### SUMMARY

The present disclosure has been made to solve the above-described problem and can be implemented as the following application example.

An aqueous adhesive composition for textile printing according to an application example of the present disclosure includes a (meth)acrylic resin having a glass transition temperature of −30° C. or more and −5° C. or less, an anionic surfactant containing an ammonium salt, and a nonionic surfactant having a cloud point of 100° C. or more.

### BRIEF DESCRIPTION OF THE DRAWINGS

FIG. 1 is Table 1 indicating compositions and evaluation results of aqueous adhesive compositions for textile printing of Examples 1 to 9.

FIG. 2 is Table 2 indicating compositions and evaluation results of aqueous adhesive compositions for textile printing of Examples 10 to 13 and Comparative Examples 1 to 5.

### DESCRIPTION OF EMBODIMENTS

Hereinafter, preferred embodiments of the present disclosure will be described in detail.

### 1 Aqueous Adhesive Composition for Textile Printing

First, an aqueous adhesive composition for textile printing according to the present disclosure will be described.

The aqueous adhesive composition for textile printing according to the present disclosure is used, for example, to form an adhesive layer on a surface of a transport belt that comes in contact with a fabric transported by the belt and subjected to textile printing.

The aqueous adhesive composition for textile printing according to the present disclosure contains a (meth)acrylic resin having a glass transition temperature of −30° C. or more and −5° C. or less, an anionic surfactant containing an ammonium salt, and a nonionic surfactant having a cloud point of 100° C. or more.

This configuration enables the adhesive layer formed of the aqueous adhesive composition for textile printing to have high durability against water washing. Furthermore, the adhesive layer formed of such an aqueous adhesive composition for textile printing enables a fabric to be stably fixed to a transport belt during transport or printing and also enables a recorded item obtained by printing to be suitably detached from the transport belt.

Furthermore, the use of water eliminates the need for an organic solvent, and thus there is no need to consider problems caused by the use of the organic solvent, specifically, no need to consider the restrictions on the surrounding environment caused by volatilization of the organic solvent. Furthermore, the amount of a curing agent or a crosslinking agent to be used in the aqueous adhesive composition for textile printing of the present disclosure can be reduced, and thus the environmental load can be reduced and the aqueous adhesive composition for textile printing can have high storage stability.

In contrast, configurations that do not satisfy the above-described conditions cannot achieve satisfactory results. For example, when the glass transition temperature of the aqueous adhesive composition for textile printing is less than the lower limit, the tack of the adhesive layer formed of the aqueous adhesive composition for textile printing is significantly high, and the detachability of the recorded item obtained by printing from the transport belt significantly decreases. Furthermore, when the glass transition temperature of the aqueous adhesive composition for textile printing exceeds the above upper limit, the tack of the adhesive layer formed of the aqueous adhesive composition for textile printing is significantly deteriorated.

Furthermore, when the aqueous adhesive composition for textile printing does not contain an anionic surfactant containing an ammonium salt, the durability of the adhesive layer formed of the aqueous adhesive composition for textile printing is significantly deteriorated.

Furthermore, when the aqueous adhesive composition for textile printing does not contain a nonionic surfactant, or when the nonionic surfactant is contained but the cloud point thereof is less than 100° C., the durability and tackiness of the adhesive layer formed of the aqueous adhesive composition for textile printing are significantly deteriorated. In addition, the storage stability of the aqueous adhesive composition for textile printing significantly decreases. When an organic solvent is contained instead of water, the above-described effects of using water cannot be obtained.

### 1-1 Water

The aqueous adhesive composition for textile printing contains water.

Water is a component that imparts fluidity to the aqueous adhesive composition for textile printing. In the aqueous adhesive composition for textile printing, water functions as a solvent for dissolving components other than water, such as a (meth)acrylic resin and a surfactant, and functions as a dispersion medium for dispersing such components.

The amount of water in the aqueous adhesive composition for textile printing is not particularly limited, but is preferably 30.0% by mass or more and 80.0% by mass or less, and more preferably 35.0% by mass or more and 70.0% by mass or less. This enables the aqueous adhesive composition for textile printing to have more suitable fluidity and viscosity and thus can improve the application properties of the aqueous adhesive composition for textile printing and the thickness uniformity of an adhesive layer formed of the aqueous adhesive composition for textile printing.

### 1-2 (Meth)acrylic Resin

The aqueous adhesive composition for textile printing contains a (meth)acrylic resin. The (meth)acrylic resin has a function of imparting tackiness to the adhesive layer formed of the aqueous adhesive composition for textile printing.

In particular, among various adhesive components, the use of a (meth)acrylic resin can make the tack of the adhesive layer more appropriate. This can also improve the water resistance and mechanical strength of the adhesive layer. Thus, for example, an unintentional decrease in tack can be more suitably inhibited when the adhesive layer formed of the aqueous adhesive composition for textile printing is brushed with water.

The (meth)acrylic resin may be a water-soluble resin or an emulsion in an aqueous dispersion medium. In particular, when the (meth)acrylic resin is an emulsion synthesized by emulsion polymerization, the tack of the adhesive layer can be made more appropriate, and the water resistance and mechanical strength of the adhesive layer can also be improved. Furthermore, this is particularly advantageous in terms of the uniformity of the film thickness of the adhesive layer and the uniformity of surface properties.

The (meth)acrylic resin is not particularly limited as long as it is a polymer containing a (meth)acrylic monomer, such as (meth)acrylic acid and (meth)acrylic acid ester, as at least a portion of the monomer component. For example, the (meth)acrylic resin may be a homopolymer obtained by polymerizing one type of (meth)acrylic monomer or may be a copolymer containing multiple types of (meth)acrylic monomer as monomer components. In addition, the (meth)acrylic resin may be a copolymer containing a monomer other than the (meth)acrylic monomer as a monomer component in addition to the (meth)acrylic monomer.

The (meth)acrylic resin constituting the aqueous adhesive composition for textile printing of the present disclosure may contain different types of polymers. For example, the (meth)acrylic resin may be obtained by blending multiple types of polymers synthesized under different conditions.

The (meth)acrylic monomer is not particularly limited, and examples thereof include a (meth)acrylic monomer having an acidic group, a (meth)acrylic monomer having an ester structure, and a (meth)acrylic monomer having an amide structure. Examples of the (meth)acrylic monomer having an acidic group include acrylic acid and methacrylic acid. Examples of the (meth)acrylic monomer having an ester structure include methyl acrylate, methyl methacrylate, ethyl acrylate, ethyl methacrylate, n-propyl acrylate, n-propyl methacrylate, butyl acrylate, butyl methacrylate, lauryl acrylate, lauryl methacrylate, isoamyl acrylate, isoamyl methacrylate, 2-ethylhexyl acrylate, 2-ethylhexyl methacrylate, cyclohexyl acrylate, and cyclohexyl methacrylate. Examples of the (meth)acrylic monomer having an amide structure include acrylamide, methacrylamide, and N-isopropylacrylamide.

The monomer other than the (meth)acrylic monomer is not particularly limited, and examples thereof include styrene and acrylonitrile.

The (meth)acrylic resin preferably contains a (meth)acrylic acid ester monomer having a linear alkyl group having 4 or more and 12 or less carbon atoms. This also can make the tack of the adhesive layer formed of the aqueous adhesive composition for textile printing more suitable, enabling the fabric to be more stably fixed to the transport belt and to be more suitably detached from the transport belt. Furthermore, this can improve the flexibility of the adhesive layer formed of the aqueous adhesive composition for textile printing. Thus, it is possible to further prevent the adhesive layer from remaining on the fabric or the adhesive layer from adhering to the cleaning brush during water washing.

Examples of the (meth)acrylic acid ester monomer having a linear alkyl group having 4 or more and 12 or less carbon atoms include butyl methacrylate, butyl acrylate, 2-ethylhexyl acrylate, and lauryl methacrylate. Among these, preferable examples include butyl acrylate and 2-ethylhexyl acrylate. This enables the (meth)acrylic resin to have a more suitable glass transition temperature and thus can improve the tack of the adhesive layer formed of the aqueous adhesive composition for textile printing.

The (meth)acrylic acid ester monomer having a linear alkyl group having 4 or more and 12 or less carbon atoms preferably has no aromatic ring. This can further improve the safety of the aqueous adhesive composition for textile printing.

The amount of the (meth)acrylic acid ester monomer having a linear alkyl group having 4 or more and 12 or less carbon atoms in the (meth)acrylic resin is preferably 40.0% by mass or more and 98.0% by mass or less, more preferably 44.0% by mass or more and 90.0% by mass or less, and still more preferably 48.0% by mass or more and 80.0% by mass or less. This can make the tack of the adhesive layer formed of the aqueous adhesive composition for textile printing more suitable, enabling the fabric to be more stably fixed to the transport belt during transport or printing and enabling the recorded item obtained by printing to be more suitably detached from the transport belt. In addition, this can improve the flexibility of the adhesive layer formed of the aqueous adhesive composition for textile printing. Thus, it is possible to further prevent the adhesive layer from remaining on the fabric or the adhesive layer from adhering to the cleaning brush during water washing.

The acid value of the (meth)acrylic resin is preferably 3 mg KOH/g or more and 10 mg KOH/g or less, more preferably 4 mg KOH/g or more and 9 mg KOH/g or less, and still more preferably 5 mg KOH/g or more and 8 mg KOH/g or less. This can improve the storage stability of the aqueous adhesive composition for textile printing and also improve the durability of the adhesive layer formed of the aqueous adhesive composition for textile printing.

The average particle diameter of the (meth)acrylic resin is preferably 100 nm or more and 300 nm or less, more preferably 120 nm or more and 280 nm or less, and still more preferably 150 nm or more and 260 nm or less. This can improve the storage stability of the aqueous adhesive composition for textile printing.

In this specification, the average particle diameter means a particle diameter (D50) at which the cumulative amount of particles calculated from the small particle size side reaches 50% by volume in a particle distribution measured by a dynamic light scattering method. To determine the average particle diameter, for example, a sample diluted with pure water at a dilution ratio of 200 may be prepared, and the average particle diameter may be determined using a Zeta-potential & Particle size Analyzer “ELSZ-1000ZS” (available from Otsuka Electronics Co., Ltd.).

The amount of the (meth)acrylic resin in the aqueous adhesive composition for textile printing is preferably 20.0% by mass or more and 70.0% by mass or less, more preferably 30.0% by mass or more and 60.0% by mass or less. This can improve the mechanical strength of the adhesive layer formed of the aqueous adhesive composition for textile printing. This can also make the tack of the adhesive layer formed of the aqueous adhesive composition for textile printing more suitable, enabling the fabric to be more stably fixed to the transport belt during transport or printing and enabling the recorded item obtained by printing to be more suitably detached from the transport belt. This can also improve the application properties and storage stability of the aqueous adhesive composition for textile printing.

The glass transition temperature of the (meth)acrylic resin is −30° C. or more and −5° C. or less, more preferably −28° C. or more and −8° C. or less, and still more preferably −25° C. or more and −10° C. or less. This allows the above-described effects to be more significantly exhibited.

The glass transition temperature of the (meth)acrylic resin may be obtained by measurement using, for example, differential scanning calorimetry (DSC), or may be calculated from the glass transition temperature of a homopolymer of each monomer component contained in the (meth)acrylic resin, using a calculation formula. When a calculation formula is used and the (meth)acrylic resin is a copolymer, the glass transition temperature Tg (unit: K) of the copolymer can be calculated from the glass transition temperature Tgₙ (unit: K) of a homopolymer of each monomer and the mass fraction Wₙ of the monomer, using the following FOX equation.

$$\frac{1}{Tg} = \frac{{W}_{1}}{{Tg}_{1}} + \frac{{W}_{2}}{{Tg}_{2}} + ... . + \frac{{W}_{n}}{{Tg}_{n}}$$

Here, Wₙ is the mass fraction of each monomer,
Tgₙ is Tg of a homopolymer of each monomer (unit: K), and
Tg is Tg of a copolymer (unit: K).

The glass transition temperatures of homopolymers of the monomer components in the (meth)acrylic resin may be determined by, for example, measurement by differential scanning calorimetry (DSC). As the glass transition temperature, those described in various documents (for example, Polymer Handbook) may be used.

### 1-3 Anionic Surfactant

The aqueous adhesive composition for textile printing contains an anionic surfactant containing an ammonium salt. The anionic surfactant containing an ammonium salt has a function of imparting durability against water washing to the adhesive layer formed of the aqueous adhesive composition for textile printing. This is because, after the aqueous adhesive composition for textile printing is applied to a transport belt and dried, ammonia volatilizes, unlike a metal salt, and thus the water resistance of the aqueous adhesive composition for textile printing is improved.

The anionic surfactant preferably contains an ammonium alkyl sulfate. An ammonium alkyl sulfate has a low critical micelle concentration. Thus, when the aqueous adhesive composition for textile printing contains an ammonium alkyl sulfate, the amount of the anionic surfactant used can be reduced, improving the tack of the aqueous adhesive composition for textile printing.

The ammonium alkyl sulfate preferably contains 12 or more carbon atoms in the molecule. This can further reduce the amount of the anionic surfactant used, improving the tack of the aqueous adhesive composition for textile printing.

The alkyl group constituting the ammonium alkyl sulfate preferably has 12 carbon atoms in the main chain. An ammonium alkyl sulfate having an alkyl group having 12 carbon atoms as a main chain has a low critical micelle concentration. This can further reduce the amount of the anionic surfactant used, improving the tack of the aqueous adhesive composition for textile printing.

The alkyl group may have a side chain. In this case, the number of carbon atoms of the ammonium alkyl sulfate may be 12 or more.

Examples of the ammonium alkyl sulfate having 12 or more carbon atoms include ammonium alkyl (C12 to C15) sulfate, ammonium alkyl (C12 to C16) sulfate, ammonium lauryl sulfate, ammonium isotridecyl sulfate, and ammonium 2-octyldodecane sulfate. Among these, ammonium lauryl sulfate is preferable.

The amount of the ammonium alkyl sulfate, based on 100 parts by mass of the (meth)acrylic resin, is preferably 0.5 parts by mass or more and 10.0 parts by mass or less, more preferably 0.7 parts by mass or more and 6.0 parts by mass or less, and still more preferably 0.8 parts by mass or more and 2.0 parts by mass or less. This can improve the durability of the adhesive layer formed of the aqueous adhesive composition for textile printing. In addition, this can improve storage stability of the aqueous adhesive composition for textile printing.

### 1-4 Nonionic Surfactant

The aqueous adhesive composition for textile printing contains a nonionic surfactant having a cloud point of 100° C. or more. The nonionic surfactant having a cloud point of 100° C. or more has a function of imparting durability against water washing, suitable tackiness, and high storage stability to the adhesive layer formed of the aqueous adhesive composition for textile printing.

The cloud point is a temperature at which a solution containing a nonionic surfactant starts to become cloudy when the temperature of the aqueous solution is increased. The cloud point can be measured, in a usual way, by dissolving a nonionic surfactant in water so as to have a concentration of 1% by mass.

When the cloud point of the nonionic surfactant is 100° C. or more, the surfactant can maintain a micelle state even in a high-temperature polymerization reaction performed during the preparation of the aqueous adhesive composition for textile printing described below. This enables the surfactant to sufficiently act during the polymerization reaction, and the prepared aqueous adhesive composition for textile printing can sufficiently exhibit the above-described function.

The nonionic surfactant is preferably composed of a nonionic compound containing no fluorine. Examples of the nonionic surfactant include ether type nonionic surfactants, such as polyoxyethylene alkyl phenyl ether, polyoxyethylene alkyl ether, and polyoxyethylene alkylene alkyl ether, polyoxyethylene derivatives, such as ethylene oxide/propylene oxide block copolymers, ester type nonionic surfactants, such as sorbitan fatty acid ester, polyoxyethylene sorbitan fatty acid ester, polyoxyethylene sorbitol fatty acid ester, glycerin fatty acid ester, and polyoxyethylene fatty acid ester, and amine nonionic surfactants, such as polyoxyethylene alkylamine and alkylalkanolamide.

In the compound constituting the nonionic surfactant, the hydrophobic group may be any of an alkylphenol group, a linear alkyl group, and a branched alkyl group, but from the viewpoint of safety, the compound is preferably one having no aromatic ring, such as a compound not having an alkylphenol group in the structure.

The amount of the nonionic surfactant, based on 100 parts by mass of the (meth)acrylic resin, is preferably 0.3 parts by mass or more and 10.0 parts by mass or less, more preferably 0.4 parts by mass or more and 5.0 parts by mass or less, and still more preferably 0.5 parts by mass or more and 1.5 parts by mass or less. This can improve the durability of the adhesive layer formed of the aqueous adhesive composition for textile printing. In addition, this can improve storage stability of the aqueous adhesive composition for textile printing.

### 1-5 Tackifier

The aqueous adhesive composition for textile printing may contain a tackifier. Examples of the tackifier include a rosin-based compound, a terpene-based compound, and a hydrocarbon resin.

More specific examples thereof include rosin-based compounds, such as natural rosins, modified rosins, glycerol esters of natural rosins, glycerol esters of modified rosins, pentaerythritol esters of natural rosins, and pentaerythritol esters of modified rosins, terpene-based compounds, such as copolymers of natural terpenes, three dimensional polymers of natural terpenes, aromatic modified terpene resins, hydrogenated derivatives of aromatic modified terpene resins, terpene phenol resins, and terpene resins (e.g., monoterpenes, diterpenes, triterpenes, and polyterpenes), and hydrocarbon resins, such as aliphatic petroleum hydrocarbon resins (C5 resins), hydrogenated derivatives of aliphatic petroleum hydrocarbon resins, aromatic petroleum hydrocarbon resins (C9 resins), such as styrene oligomers, and hydrogenated derivatives of aromatic petroleum hydrocarbon resins.

When the aqueous adhesive composition for textile printing contains the tackifier, the amount of the tackifier in the aqueous adhesive composition for textile printing is not particularly limited, but is preferably 5.0% by mass or less, more preferably 4.0% by mass or less, and still more preferably 0.1% by mass or more and 3.8% by mass or less. This can make the tack of the adhesive layer formed of the aqueous adhesive composition for textile printing more suitable and enables the effect of inhibiting a decrease in the tack of the adhesive layer due to brushing to readily last over a longer period of time.

### 1-6 Coloring Material

The aqueous adhesive composition for textile printing may contain a coloring material. As the coloring material, for example, various pigments and various dyes can be used.

When the aqueous adhesive composition for textile printing contains the coloring material, the amount of the coloring material in the aqueous adhesive composition for textile printing is preferably 1.0% by mass or less, and more preferably 0.5% by mass or less.

### 1-7 Other Components

The aqueous adhesive composition for textile printing may contain components other than those described above. Hereinafter, such components are also referred to as “other components”.

Examples of other components include resin materials other than the (meth)acrylic resin, antioxidants, colorants, antistatic agents, flame retardants, flame retardant aids, ultraviolet absorbents, aggregation inhibitors, processing aids, plasticizers, defoaming agents, anionic surfactants not containing an ammonium salt, and nonionic surfactants having a cloud point of less than 100° C.

However, it is preferable that the aqueous adhesive composition for textile printing do not contain an anionic surfactant not containing an ammonium salt, or if it contains an anionic surfactant not containing an ammonium salt, it is preferable that it contain only a small amount of the anionic surfactant not containing an ammonium salt. More specifically, the amount of the anionic surfactant not containing an ammonium salt in the aqueous adhesive composition for textile printing is preferably 0.05% by mass or less, more preferably 0.03% by mass or less, and still more preferably 0.01% by mass or less.

Furthermore, it is preferable that the aqueous adhesive composition for textile printing do not contain a nonionic surfactant having a cloud point of less than 100° C., or if it contains a nonionic surfactant having a cloud point of less than 100° C., it is preferable that it contain only a small amount of the nonionic surfactant having a cloud point of less than 100° C. More specifically, the amount of the nonionic surfactant having a cloud point of less than 100° C. in the aqueous adhesive composition for textile printing is preferably 0.05% by mass or less, more preferably 0.03% by mass or less, and still more preferably 0.01% by mass or less.

Examples of the resin material other than the (meth)acrylic resin include urethane resins, silicone resins, and various elastomers (rubber-based materials).

The amount of the other components in the aqueous adhesive composition for textile printing is preferably 10.0% by mass or less, more preferably 5.0% by mass or less, and still more preferably 3.0% by mass or less.

In particular, it is preferable that the aqueous adhesive composition for textile printing do not contain an organic solvent, or if it contains an organic solvent, it is preferable that it contain only a small amount of the organic solvent in view of reducing the environmental load and restrictions on the surrounding environment caused by volatilization of the organic solvent. More specifically, the amount of the organic solvent in the aqueous adhesive composition for textile printing is preferably 5.0% by mass or less, more preferably 2.5% by mass or less, and still more preferably 0.5% by mass or less.

In addition, it is preferable that the aqueous adhesive composition for textile printing do not contain a curing agent or a crosslinking agent, or if it contains a curing agent or a crosslinking agent, it is preferable that it contain only a small amount of the curing agent or the crosslinking agent in view of reducing the environmental load and improving the storage stability. More specifically, the amount of the curing agent or the crosslinking agent in the aqueous adhesive composition for textile printing is preferably 5.0% by mass or less, more preferably 2.5% by mass or less, and still more preferably 0.5% by mass or less.

### 1-8 Other Conditions

The pH of the aqueous adhesive composition for textile printing at 23° C. is preferably 7.5 or more and 9.5 or less, more preferably 7.7 or more and 9.3 or less, and still more preferably 7.9 or more and 9.0 or less. This can more effectively reduce the hydrolysis of the (meth)acrylic resin and enables the adhesive layer formed of the aqueous adhesive composition for textile printing to more stably keep the durability. This can also improve the storage stability of the aqueous adhesive composition for textile printing.

The viscosity at 23° C. of the aqueous adhesive composition for textile printing is not particularly limited, but is preferably 5 mPa-s or more and 1000 mPa-s or less, and more preferably 10 mPa-s or more and 300 mPa-s or less. This can improve the handleability at the time of applying the aqueous adhesive composition for textile printing and more suitably prevent unintentional variations in the thickness and surface properties of the adhesive layer to be formed.

The storage modulus at 23° C. of the adhesive layer formed of the aqueous adhesive composition for textile printing is preferably 1.5×10⁵ Pa or more and 5.0×10⁵ Pa or less, more preferably 1.6×10⁵ Pa or more and 4.8×10⁵ Pa or less, and still more preferably 2.0×10⁵ Pa or more and 4.5×10⁵ Pa or less.

The adhesive layer whose storage modulus is measured may be formed by any method. For example, the adhesive layer may be formed by a method in which an aqueous adhesive composition for textile printing is applied to a 25 mm wide slide glass to have a thickness of 0.2 mm under an environment of 23° C. and dried at 50% RH and 23° C. for 8 hours.

Although the preferred embodiments of the present disclosure have been described above, the present disclosure should not be limited to the embodiments.

### EXAMPLES

Next, specific examples of the present disclosure will be described, but the present disclosure should not be limited thereto. Of the treatments and measurements in the following Examples, those where the temperature condition is not indicated were performed at room temperature (23° C.).

### 2 Preparation of Aqueous Adhesive Composition for Textile Printing

### 2-1 Example 1

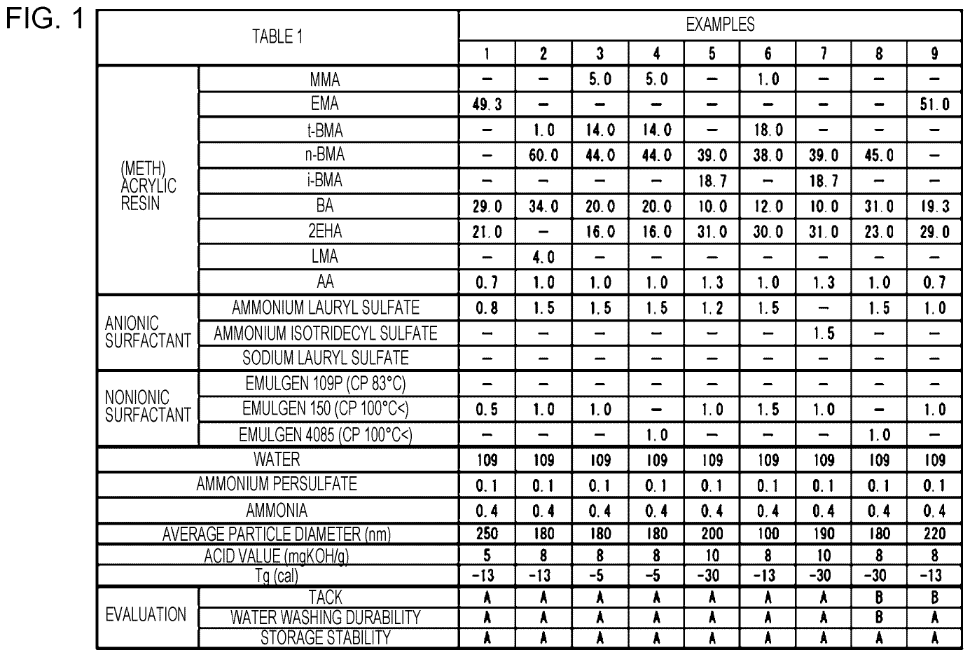

To a reactor equipped with a stirrer, a reflux condenser, a thermometer, a nitrogen introduction tube, and a dropping funnel, 226.3 g of ion exchange water was added and heated to 82° C. Then, a total of 471.5 g of monomers weighed to have the composition ratio of the acrylic resin indicated in Example 1 of FIG. 1, 135.5 g of ion exchange water, 15.7 g of an ammonium lauryl sulfate solution (solid content: 24% by mass), and 3.4 g of an EMULGEN 150 solution (solid content: 70% by mass) were added, mixed, and stirred. To the homogenized mixture, 135.8 g of a 3.5% by mass ammonium persulfate solution as a polymerization initiator was added over 1.5 hours at 82° C. After all the above-described components were added, the mixture was kept warm for one hour and then cooled. Then, 9.0 g of ion exchange water was added to the mixture, and 15.8 g of 12% by mass ammonia water was used so that the mixture had a pH of 8 or more and 9 or less. The mixture was filtered through a 150 mesh nylon filter to remove coarse particles, and thus an aqueous dispersion of the (meth)acrylic resin, that is, the aqueous adhesive composition for textile printing according to the present disclosure, was obtained. The composition of the obtained aqueous adhesive composition for textile printing was as indicated in FIG. 1.

### 2-2 Examples 2 to 13 and Comparative Examples 1 to 5

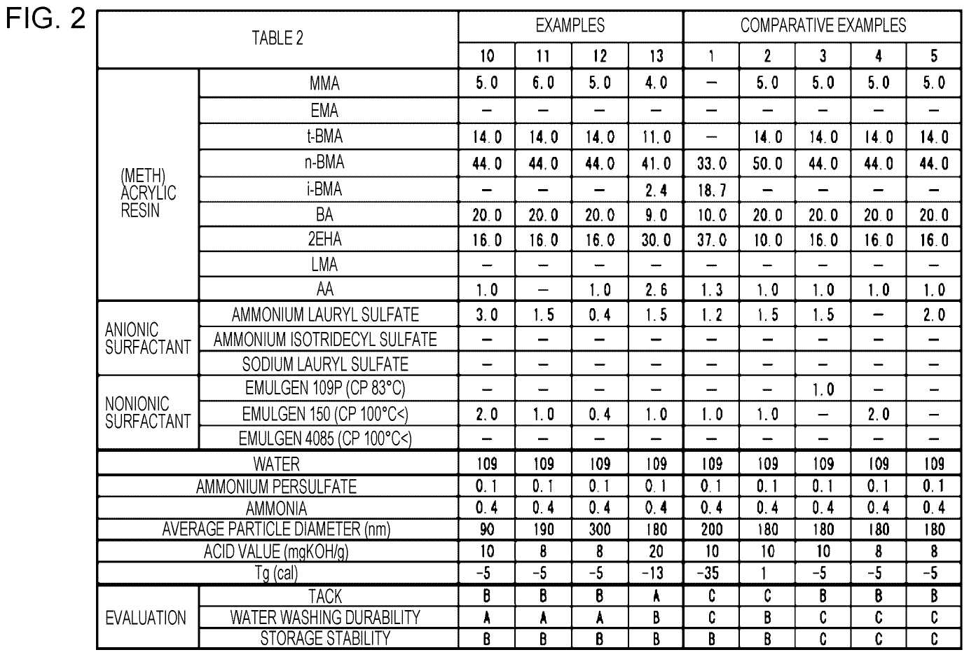

Aqueous adhesive compositions for textile printing were each prepared in the same manner as in Example 1, except that the types and amounts of the components used were adjusted so as to have the composition indicated in FIGS. 1 and 2. Comparative Example 4 did not use an anionic surfactant, and Comparative Example 5 did not use a nonionic surfactant.

FIGS. 1 and 2 collectively show the compositions of the aqueous adhesive compositions for textile printing of Examples and Comparative Examples. The “(meth)acrylic resin” section in FIGS. 1 and 2 shows the amounts of (meth)acrylic monomers in the (meth)acrylic resin, and the unit for the values is % by mass. The “anionic surfactant” and “nonionic surfactant” sections in FIGS. 1 and 2 show the amounts of the surfactants based on 100 parts by mass of the (meth)acrylic resin, and the unit for the values is parts by mass. In addition, the “water”, “ammonium persulfate”, and “ammonia” sections in FIGS. 1 and 2 show the amounts of the respective components based on 100 parts by mass of the (meth)acrylic resin, and the unit for the values is parts by mass.

In FIGS. 1 and 2, “MMA” is methyl methacrylate, “EMA” is ethyl methacrylate, “t-BMA” is tert-butyl methacrylate, “n-BMA” is n-butyl methacrylate, “i-BMA” is iso-butyl methacrylate, “BA” is butyl acrylate, “2EHA” is 2-ethylhexyl acrylate, “LMA” is lauryl methacrylate, and “AA” is acrylic acid. BMA, BA, 2EHA, and LMA each have a linear alkyl group having 4 or more and 12 or less carbon atoms.

Furthermore, “EMULGEN 109P” is EMULGEN 109P (trade name, available from Kao Corporation), which is polyoxyethylene lauryl ether as a nonionic surfactant. Furthermore, “EMULGEN 150” is EMULGEN 150 (trade name, available from Kao Corporation), which is polyoxyethylene lauryl ether as a nonionic surfactant. Furthermore, “EMULGEN 4085” is EMULGEN 4085 (trade name, available from Kao Corporation), which is polyoxyethylene myristyl ether as a nonionic surfactant. Furthermore, “Tg” is a glass transition temperature, and “CP” is a cloud point.

The glass transition temperature (Tg) of the (meth)acrylic resin is a value calculated from the glass transition temperature of a homopolymer of each monomer component using the above-described FOX equation. The glass transition temperatures of homopolymers of the monomer components were determined by measurement using a differential scanning calorimeter “DSC8000” (available from Perkin Elmer Co., Ltd) in accordance with JIS K 7121. The average particle diameter is a value of D50 determined by measurement using a Zeta-potential & Particle size Analyzer “ELSZ-1000ZS” (available from Otsuka Electronics Co., Ltd). The acid value is a value obtained by acid value measurement in accordance with JIS K 2501.

### 3 Evaluation of Aqueous Adhesive Composition for Textile Printing

The aqueous adhesive compositions for textile printing of Examples and Comparative Examples were evaluated as follows.

### 3-1 Tack

The aqueous adhesive composition was applied to a glass plate so as to have a thickness of 0.2 mm and dried at 25% RH and 50° C. for 30 minutes to form an adhesive layer. Next, the adhesive layer formed as described above and a cotton fabric having a width of 50 mm were press-bonded with a roller under a pressure of 1 kgf/50 mm. Next, the cotton fabric was detached from the adhesive layer in a 180° direction at 23° C., and the tack (180° peel force) was measured and evaluated according to the following evaluation criteria. The higher the numerical value of the 180° peel force, the higher the tack, and unintentional detachment of the fabric during transport can be prevented.
A: 1.0 N/50 mm or more and less than 5.0 N/50 mm
B: 0.1 N/50 mm or more and less than 1.0 N/50 mm
C: less than 0.1 N/50 mm

### 3-2 Water Washing Durability

The aqueous adhesive composition was applied to a glass plate so as to have a thickness of 0.2 mm and dried at 25% RH and 50° C. for 30 minutes to form an adhesive layer. Next, a nylon brush wetted with water was rotated at 200 rpm and pressed against the adhesive layer formed as described above at a pressure of 1.0 N/cm. After the elapse of 200 hours, the rotation of the brush was stopped, and the surface of the adhesive layer was visually observed and evaluated according to the following criteria. The smaller the change in appearance such as scratches, unevenness, and peeling in the surface of the adhesive layer after the pressing, the better the durability against water washing. The nylon brush used was made of nylon 6,10 and had a bristle diameter of 0.3 mm, a bristle length of 30 mm, and a brush diameter of 16 mm. The brush was kept wet with water during the rotation.
A: No scratches can be seen.
B: Slight scratches can be seen.
C: Significant unevenness or peeling can be seen.

### 3-3 Storage Stability

Into a 200 ml glass bottle, 100 g of the aqueous adhesive composition for textile printing was put, and the glass bottle was sealed. After the glass bottle was left to stand at 60° C. in a thermostatic chamber for 2 weeks, the state of the adhesive composition was visually observed. Then, evaluation was performed according to the following criteria.
A: No thickening or aggregation can be seen.
B: Slight thickening or aggregation can be seen.
C: Significant thickening or aggregation can be seen.

The evaluation results are collectively indicated in FIGS. 1 and 2. As is clear from FIGS. 1 and 2, Examples showed excellent results. In contrast, Comparative Examples did not show satisfactory results.

What is claimed is:

1. An aqueous adhesive composition for textile printing, comprising:
a (meth)acrylic resin having a glass transition temperature of −30° C. or more and −5° C. or less;
an anionic surfactant containing an ammonium salt; and
a nonionic surfactant having a cloud point of 100° C. or more.

2. The aqueous adhesive composition for textile printing according to claim 1, wherein an amount of the nonionic surfactant is 0.3 parts by mass or more and 10.0 parts by mass or less based on 100 parts by mass of the (meth)acrylic resin.

3. The aqueous adhesive composition for textile printing according to claim 1, wherein the anionic surfactant contains an ammonium alkyl sulfate.

4. The aqueous adhesive composition for textile printing according to claim 3, wherein the ammonium alkyl sulfate has 12 or more carbon atoms in a molecule thereof.

5. The aqueous adhesive composition for textile printing according to claim 3, wherein an amount of the ammonium alkyl sulfate is 0.5 parts by mass or more and 10.0 parts by mass or less based on 100 parts by mass of the (meth)acrylic resin.

6. The aqueous adhesive composition for textile printing according to claim 1, wherein the (meth)acrylic resin contains a (meth)acrylic acid ester monomer having a linear alkyl group having 4 or more and 12 or less carbon atoms.

7. The aqueous adhesive composition for textile printing according to claim 6, wherein an amount of the (meth)acrylic acid ester monomer in the (meth)acrylic resin is 40.0% by mass or more and 98.0% by mass or less.

8. The aqueous adhesive composition for textile printing according to claim 1, wherein the (meth)acrylic resin has an acid value of 3 mg KOH/g or more and 10 mg KOH/g or less.

9. The aqueous adhesive composition for textile printing according to claim 1, wherein the (meth)acrylic resin has an average particle diameter of 100 nm or more and 300 nm or less.
